(19) United States
(12) Patent Application Publication
(10) Pub. No.: US 2008/0282312 A1
(43) Pub. Date: Nov. 13, 2008

(54) SYSTEM AND METHOD FOR ALLOCATING TUNER AND/OR RECORDING RESOURCES

(75) Inventor: Tomi Jussi Blinnikka, Berkeley, CA (US)

Correspondence Address: Yahoo! Inc., c/o Kenyon & Kenyon LLP, 333 W. San Carlos Street, Suite 600, San Jose, CA, 95110, US

(73) Assignee: Yahoo! Inc., Sunnyvale, CA (US)

(21) Appl. No.: 11/746,003

(22) Filed: May 8, 2007

(51) Int. Cl. H04N 7/16

(52) U.S. Cl. 725/153

(57) ABSTRACT

A system and method of implementing a distributed recording capability may be employed to allocate tuner resources among connected recorder devices, including digital video recorder (DVR) devices. In accordance with one aspect, a server may receive a request to record a multimedia broadcast from a user. The server may search a network for a recorder device having an available tuner from among a plurality of recorder devices connected to the network using predetermined search criteria. The server may transmit a command over the network to the identified recorder device to record the requested multimedia broadcast. The identified recorder device may automatically transfer the recorded multimedia broadcast over the network to a user-associated recorder device.

### BACKGROUND

1. Field of the Invention

Aspects of the present invention relate generally to allocation of tuner and/or recording resources, more particularly to a system and method for allocating resources, including tuner and/or recording resources, in a distributed digital video recorder (DVR) system.

2. Description of Related Art

Standalone digital video recorders (DVRs) or personal video recorders (PVRs) have begun supplanting video cassette recorders (VCRs) and digital versatile disk (DVD) systems as the preferred devices for recording television (TV) broadcast signals (i.e., video and accompanying audio). Unlike VCRs, which record TV signals to a limited capacity videotape cassette, or DVD systems, which record to a limited capacity disk, DVRs and PVRs record TV signals to hard drive-based storage media having a much larger storage capacity. Generally, DVRs and PVRs may include a processor, a video encoder/decoder, a data storage medium, and one or more tuners. PVRs also may be implemented as software programs that reside on personal computers and enable video capture and playback using a TV tuner card.

A tuner in a DVR or a TV tuner card receives an analog or digital TV signal corresponding to a TV channel. If the received signal is in an analog format, the video encoder/decoder in the DVR or PVR samples and compresses the analog signal to provide a digital signal for viewing or recording. If the received signal is digital, sampling and compression generally are not required, and the digital signal only needs to be captured for viewing or recording. If the received TV signal is to be recorded, the tuner must remain tuned to the particular TV signal for the duration of the recording, thus preventing a user from watching or recording TV content broadcast by other TV channels while the DVR or PVR is recording. Recently, some DVRs and PVRs have incorporated two or more tuners to enable a user to watch one channel while recording another channel, or record TV content from two channels simultaneously. However, the ability to watch and record multiple TV shows and movies simultaneously is dependent on the number of available tuners in the DVR or PVR.

Further, the ability to record TV content from multiple TV channels has not kept pace with the proliferation of channels offered by cable and satellite TV companies. It is not uncommon for a user to desire to simultaneously watch and record content from more TV channels than there are available tuners. However, as DVRs and PVRs are generally standalone devices, if all tuners of a DVR or PVR are occupied with recording and a user desires to watch or record additional content, the user either is forced to obtain an additional DVR to record or watch the additional content, or the user must forego watching or recording the additional content.

Thus, it would be desirable to provide a system and method to make unused tuner DVR and PVR resources available to a user.

### SUMMARY

Embodiments of the present invention overcome the above-mentioned and various other shortcomings of conventional technology, providing a system and method of implementing a distributed recorder to allocate tuner resources among connected recorder devices. Such a method and system may employ a network to connect standalone DVRs and PVRs and to enable allocation of tuner resources between connected DVRs and PVRs. In this regard, “network” refers to any technology enabling connection of plural DVRs and/or PVRs, whether such devices be co-located or locally or geographically dispersed.

In accordance with one aspect, a server may receive a request from a user to record a multimedia broadcast. Using predetermined search criteria, the server may search for a recorder device having an available tuner from among a plurality of connected recorder devices. The server may transmit a command to the identified recorder device to record the requested multimedia broadcast. The identified recorder device may automatically transfer the recorded multimedia broadcast to a user-associated recorder device.

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a simplified diagram illustrating one embodiment of a system for allocating tuner resources among connected recording devices.

FIG. 2 is a simplified diagram illustrating one embodiment of an apparatus within a server which allocates tuner resources among a set of connected recorder devices.

FIG. 3 is a simplified flow diagram illustrating operation of one embodiment of a method of implementing a distributed recorder system.

### DETAILED DESCRIPTION

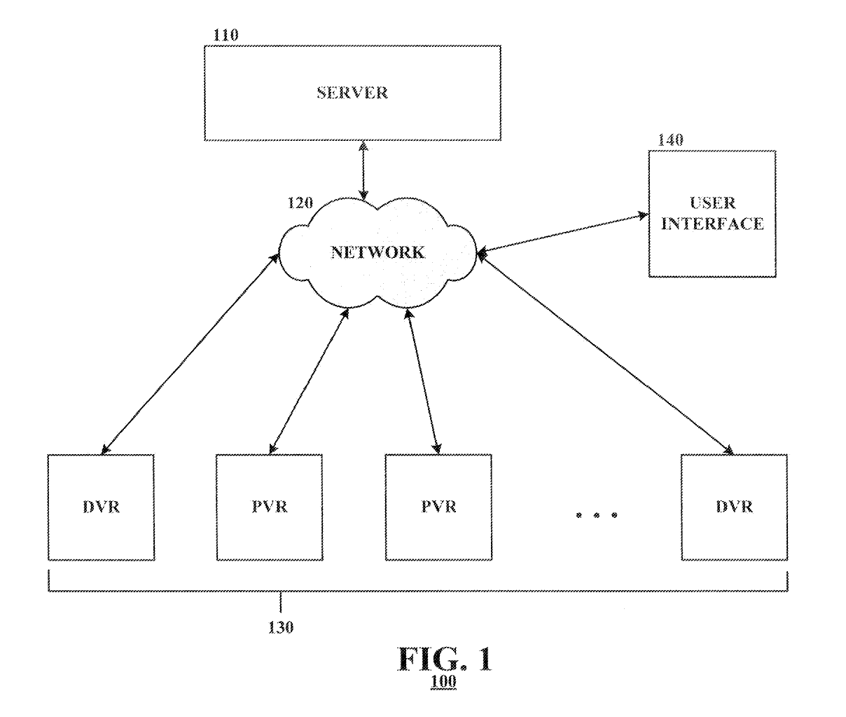

FIG. 1 is a simplified diagram illustrating one embodiment of a system for allocating tuner resources among connected recording devices. The system 100 includes a plurality of connected recorders 130 and one or more servers 110 coupled together by a network 120. The connected recorders 130 may be standalone recorder devices, such as a digital video recorder (DVR), a personal video recorder (PVR), or any recorder device which uses a tuner to receive a multimedia broadcast or program, such as a television signal corresponding to a television channel, and which records the multimedia broadcast or program. Examples of DVRs able to connect to the system may include DVRs manufactured and distributed by TiVo and ReplayTV, as well as DVRs incorporated into set-top receivers distributed by Comcast, DirecTV, and other cable and satellite companies. Examples of PVRs able to connect to the system may include software programs, such as MythTV, Freevo, and SageTV, or any other software program running on a personal computer or other computing device capable of recording television broadcasts received by a tuner card.

Each recorder 130 may have one or more tuners or tuner cards to receive television (TV) signals corresponding to TV channels or stored video (e.g., Video On Demand) in an analog or digital format. The received TV signals or video may be broadcast over the air (e.g. through broadcast TV or via satellite, for reception through a satellite dish), through a cable, such as a coaxial cable, or delivered using Internet Protocol over a network infrastructure such as fiber optic cable (e.g., IPTV or Internet television). Skilled practitioners in the art should recognize that the present disclosure is not intended to be limited as to the methods and infrastructure through which multimedia content is broadcasted or transmitted to a recorder. A user may record a program being broadcast on one of the received channels. If a program is recording, the tuner becomes occupied and prevents a user from watching or recording a different program at that same time. In order to watch or record a different program, the user must either wait for the program to stop recording or cancel the recording of the program.

The standalone recorders 130 may be connected to each other and/or to a server or servers 110 through a network 120. In one embodiment, the recorders 130 may initiate and maintain a network connection with the server or servers 110. Having the recorders 130 initiate the connection may avoid any firewall issues arising from the server(s) 110 attempting to connect to the recorder. Alternatively, the recorders 130 may poll the server(s) 110 at various intervals to determine if any commands have been issued by the server(s) 110. The server(s) 110 may be configured to communicate with each recorder device 130 on the network 120 to determine which recorder devices have available, unused tuners. The server(s) 110 may store a central schedule, in a database or other searchable data structure, for all programs broadcast to the connected recorders 130. In response to a program selection from the central schedule, the server(s) 110 may issue commands to a recorder with an unused tuner to record the selected program.

The server(s) 110 and the recorders 130 may be configured to permit remote access by a user from any device, including, for example, a personal computer, a mobile device, or the user's own recorder. The user may access the server(s) or the user's own recorder through a user interface 140 provided as part of the system 100. In one embodiment, the system 100 may authenticate the user before permitting the user to remotely access the server(s) 110 or the user's own recorder. If an account is maintained for each user, the server(s) 110 also may verify whether the user's account is in good standing. Upon authentication, the user may access the central schedule of programs through the user interface 140 to view and select a program to be recorded. In one embodiment, the central schedule may contain listings of all programs available to be recorded on the connected recorders 130. Alternatively, the user may access a local copy of the schedule of programs residing on the user's own recorder. In the event the user selects a program to be recorded from the local copy of the schedule of programs, the recorder may transmit the program selection to the server. Upon the selection of a program to be recorded, the server(s) 110 may employ a priority system to find and commandeer an unused tuner to record the program selection. Upon completion of the recording, if the recorder employed to record the program is not the user's own recorder, the employed recorder transmits the program to the user's recorder through the network 120. The transmission of the recorded program may occur using any known transmission protocols, including but not limited to peer-to-peer transfer, file transfer protocol (FTP), transmission control protocol (TCP), hypertext transfer protocol (HTTP), and streaming audio/video transmission protocols.

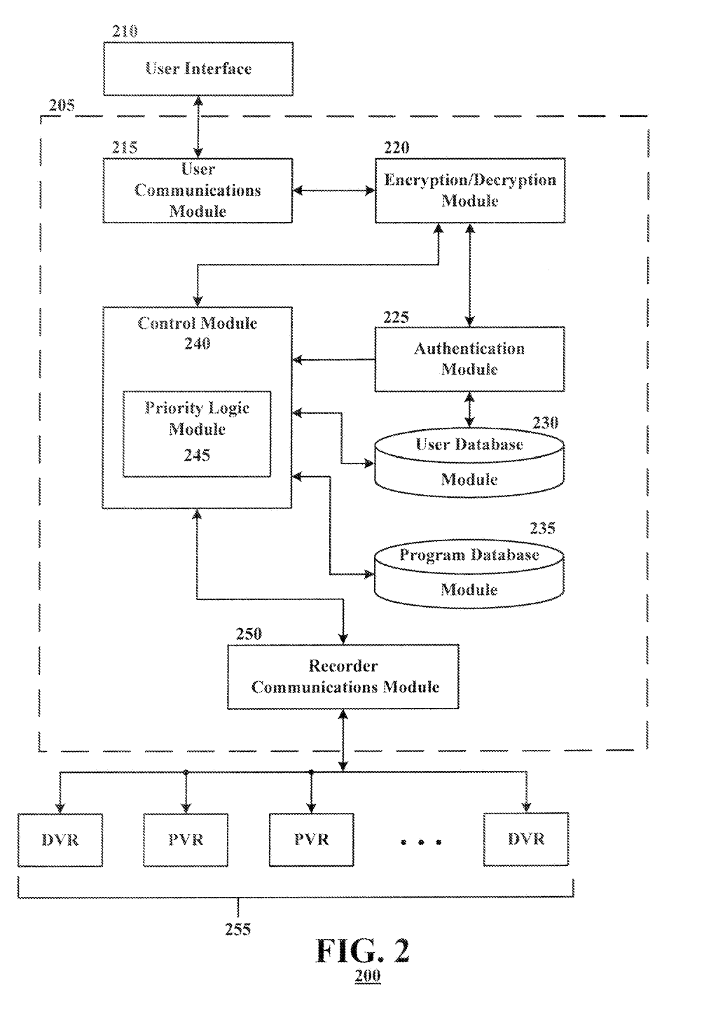

FIG. 2 is a simplified diagram of one embodiment of an apparatus within a server which allocates tuner resources among a set of connected recorder devices. The apparatus 205 may include a user communications module 215, an encryption/decryption module 220, an authentication module 225, a user database module 230, a program database module 235, a control module 240 having a priority logic module 245, and a recorder communications module 250.

A remote user may communicate with the server or the user's own recorder through a user interface 210. The user interface 210 may be resident on any device capable of remotely accessing the server or recorder, such as a personal computer, mobile device, terminal, or PDA. Communications between the user and the server may be processed by the user communications module 215, through which the server may receive the remote user's login or account identification and password. The user communications module 215 may receive program selection requests from the user and may transmit the results of the program selection request to the user. The user communications module 215 may alert the remote user upon the completion of recording the user's requested program. The user communications module 215 may transmit to the remote user for display a schedule of programs to be recorded. If the user decides not to record the selected program, the user may submit a request to modify the recording of the selected program. One modification may be to cancel the requested recording.

In one embodiment, communications sent between the user and the server may be encrypted using conventionally known cryptographic protocols, such as, for example, Transport Layer Security (TLS) and Secure Sockets Layer (SSL). Communications received by the user communications module 215 may be decrypted by an encryption/decryption module 220 before being processed. Results stemming from a user program record request likewise may be encrypted by the encryption/decryption module 220 before being transmitted back to the user through the user communications module 215.

An authentication module 225 may authenticate the remote user after decryption of the user's transmitted login and password by comparing the user's submitted login and password to a previously stored login and password. The authentication module 225 may interact with a user database module 230 to compare the submitted credentials to stored user credentials. The user database module 230 also may store account information or permissions for each user. Account information may include but is not limited to the programming package to which the user has subscribed, whether the user's account is current and valid, and how often the user has used the remote tuner capabilities of the system. Once authenticated, the remote user may access the system to remotely record a program, subject to any account limitations.

The program database module 235 may store a master schedule of all television programs accessible by any of the connected recorders 255. The master schedule may include local schedules of television programs for each geographic time zone from which the recorders are connected. As a result, the programs may include the same program broadcast multiple times during the day to account for different time zones by a channel. A remote user thus may have multiple opportunities to record a program in the event the user forgets or fails to record the program when it is aired in the user's own time zone. The program database module 235 also may store a list of all recorders actively connected to the network. A recorder may be actively connected to the network if the recorder has initiated and maintained a connection to the server such that the server may send instructions to the recorder and receive status updates from the recorder. In one embodiment, the program database module may store the master schedule of television programs, while the list of all actively connected recorders may be stored in a separate database module or server.

The control module 240 receives user requests through the user communications module and issues commands to connected recorders 255. Upon submission of a user record request, the control module 240 may access the user database module 230 to determine whether a user has permission to record the program (i.e., whether a user is attempting to record a program from a channel he has paid for). If the user is authorized to record programming from the requested channel, the control module 240 may access the program database module 235 to verify the program to be recorded is on the master schedule. The control module 240 may engage the program database module 235 or other database storing the list of actively connected recorders to find an active connected recorder to record the show.

A priority logic module 245 in the control module may determine which active connected recorder will fulfill the remote user's record request. The priority logic module 245 may first check the user's own recorder to determine whether it has an available tuner to record the requested program, thereby eliminating the need for recording the program on a different recorder and unnecessarily occupying network bandwidth when the recorded program is transmitted to the user's recorder. If the user's own recorder lacks an available tuner or is otherwise unable to record the show, the priority logic module 245 may employ a search method to find an active connected recorder with an available tuner to record the show. In one embodiment, the priority logic module 245 may find the geographically closest active connected recorder with an available tuner in relation to the user's own recorder. Alternatively, the priority logic module 245 may search for the active connected recorder with the fastest network connection or fastest transfer speed relative to the user's own recorder. Those of skill in the art will appreciate that other search methodologies may be used to discover an active connected recorder with an available tuner.

Upon identification of an active connected recorder with an available tuner, the control module 240 may issue a command to the recorder to record the requested program. During and upon completion of recording, the control module 240 may process status updates sent by the connected recorders 255. Alternatively, the control module 240 may poll the connected recorders 255 at predetermined intervals for status updates. The status updates may notify the control module 240 that, among other things, recording has failed or recording has completed. Based on the status updates, the control module 240 may issue additional commands to the connected recorders 255 to re-initiate recording of the program in the event of a recording error or transfer the recorded program to the user's own recorder.

In one embodiment, an owner of a connected recorder may have an override or first priority for his or her respective recorder. In the event a remote user is recording a program on the owner's recorder and the owner wishes to use his or her own recorder, the owner may override the recording of the remote user's selected program to use the tuner to watch a program or record a program. In this case, the owner's connected recorder may send a status update to the control module of the system to notify the system that recording of the remote user's requested program was preempted by the owner of the connected recorder. Similarly, if a program is recording on a recorder (the user's own recorder or a remotely connected recorder), and the recorder loses the signal, thereby interrupting recording of the program, the recorder may send a status update to the control module of the system to notify the system that recording was interrupted. For either case, the priority logic module 245 may identify another active connected recorder with an available tuner to record the remaining portion of the remote user's requested program. The priority logic module 245 may employ similar search methods as described above for identifying a substitute active recorder. At the conclusion of the recording, each recorder storing a portion of the requested program may automatically transfer the respective portion of the program to the remote user's recorder, where the program is spliced together for the remote user's viewing. Joining of the program portions by the remote user's recorder may be accomplished using known methods of joining together audio/video data. In one embodiment, the control module 240 may issue a command to the connected recorder which was originally recording to program to preserve the program portion. This command may entail locking or restricting the program portion from being deleted or erased before its transfer. Alternatively, an owner of a connected recorder may allocate a certain amount of storage space for storing programs recorded by remote users. The programs stored in this allocated space may be arranged in chronological order of their date of recording, with newly recorded programs overwriting the oldest recorded programs.

The recorder communications module 250 may facilitate communication between the server and the connected recorders 255. Through the recorder communications module 250, the control module 240 may transmit an instruction to a recorder with an available tuner to record a selected program. Using the recorder communications module 250, the control module 240 may communicate with each connected recorder 255 to determine which recorders have unused tuners. The recorder communications module 250 also may receive status updates from the connected recorders 255. Alternatively, the recorder communications module 250 may poll the connected recorders 255 for status updates. The status updates may include but are not limited to updates sent from the recorder indicating that a program has been recorded, a program has been transferred to the requesting recorder, recording of the program was interrupted, or transfer of the program was interrupted. Based on the status updates, the recorder communications module 250 may track the recording of a program and the progress of a file transfer between two or more recorders. In the event a recorder is busy or unavailable to transfer a recorded file, the control module 240 may issue additional commands to recorder(s) to transfer the recorded program at a later time.

In one embodiment, the networking of recorders 255 may result from users volunteering to share their respective recorders in a cooperative arrangement that lets them use each other's unused tuners and/or storage capacity. In addition, the priority override described above may be unnecessary if the user's recorder has multiple tuners, for example, in which case the user may be able to view a program using one tuner, while another tuner is recording a program for another connected user.

In another embodiment, a company may make multiple tuners and recorders available for overflow recording, providing a subscription service which users can sign up for. Combinations of the preceding embodiments also are possible.

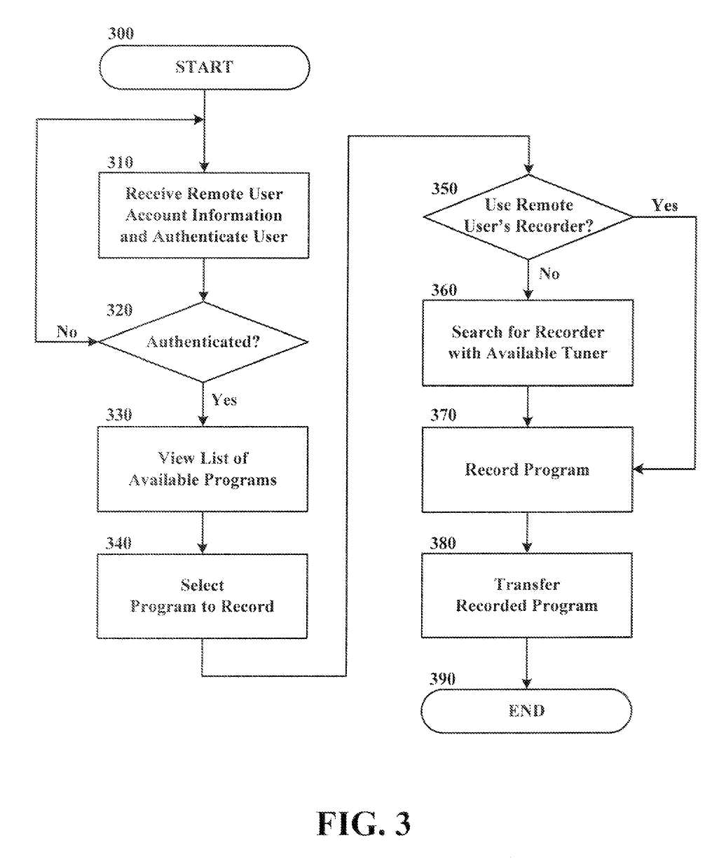

FIG. 3 is a simplified flow diagram illustrating operation of one embodiment of a method of implementing a distributed recorder system. In block 310, a server 110 in a distributed recorder system 100 may receive account information, such as a user identifier and password, from a remote user. In decision block 320, the server 110 may authenticate the user by comparing the received user identifier and password with stored user identifiers and passwords. If the authentication process fails, the server 110 may request that the remote user re-initiate the authentication process of block 310. If the user is successfully authenticated, the server 110 may permit the remote user to access the distributed recorder system 100. The remote user may access a local schedule of programs available to be recorded or a central schedule of programs available to be recorded in block 330. In block 340, the remote user may select a program from the local or central schedule to be recorded. In one embodiment, a remote user may be able to record only those programs broadcast by channels that are a part of the remote user's programming package. A limited-time subscription to an upgraded service also maybe possible, for the purpose of allowing a remote user to record a special program. Pay-per-view is one example of a limited-time subscription; others will be known to ordinarily skilled artisans, not necessarily entailing a pay-per-view capability on the remote user's existing account.

In decision block 350, after a remote user has selected a program to be recorded, the server 110 may determine whether the user's own connected recorder is available to record the requested program (i.e., whether the user's own recorder has an available tuner at the time of the requested program). If so, in block 370, the server 110 may record the requested program on the user's own connected recorder, thereby eliminating the need to transfer the recorded program over the network 120 after recording is completed. If the user does not have a connected recorder or has a connected recorder without an available tuner, in block 360, the server 110 may search among the connected recorders 130 for a recorder with an available tuner at the time of the requested program. In one embodiment, the server 110 may search for the connected recorder closest in distance to the user's location or connected recorder. Alternatively, the server 110 may search for the connected recorder having the fastest network connection or fastest transfer speed relative to the user's connected recorder. Upon identification of a suitable connected recorder, the server 110 may instruct the identified recorder to record the requested program in block 370. If the recording of the requested program is interrupted, the server 110 may identify another connected recorder having an available tuner to finish recording the program.

Upon completion of recording of the requested program, In block 380, the identified non-user recorder may automatically transfer the recorded program to the user's recorder. Transfer of the file may be accomplished using conventionally known data transfer protocols, such as peer-to-peer file sharing, FTP, HTTP, and MPEG transport stream. In one embodiment, the recorded program may be streamed over the network from the source recorder to the destination recorder. The server 110 may track the transfer of the program through status updates sent by the recorder during transfer. In the event the transfer is interrupted, the server 110 may re-initiate the transfer or schedule the transfer for a different time. If multiple connected recorders were used to record the requested program, each recorder may transfer its portion of the recorded program to the destination recorder. To prevent any of the recorders from erasing or recording over the recorded portion of the program, the server 110 may issue a command to each recorder to retain the recorded portion of the program until the portion is transmitted to the user-associated recorder. The user-associated recorder may join and reassemble the recorded program using conventionally known methods for joining multimedia content.

Those of skill in the art will appreciate that a distributed recorder system may be enabled to facilitate the recording of programs in excess of the tuner capacity of a standalone recorder. The present disclosure is not intended to be limited with respect to the number or type of recorder devices capable of connecting to the system, nor the type of multimedia content capable of being recorded by a recorder. For example, while video systems have been described, the invention is applicable to various types of audio and/or visual media as well. In any event, the inventive system is not intended to be used to violate copyright laws of the United States or other nations and therefore may employ whatever safeguards are needed to comply with such laws.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. An apparatus for distributing tuner resources among connected recorder devices, the apparatus comprising:
at least one database module configured to store a broadcast schedule of multimedia content and a roster of active connected recorder devices among the connected recorder devices;
a user communications module configured to receive user identification information from a user, transmit the broadcast schedule and a schedule of programs to be recorded to a user, receive from the user a multimedia content choice selected from the broadcast schedule or a locally stored broadcast schedule, and receive from the user a request to modify the selected multimedia content choice;
a control module to issue commands to the connected recorder devices and process status updates from the connected recorder devices, said control module comprising a priority logic module, responsive to the multimedia content choice, configured to search for and identify a connected recorder device having an available tuner from the roster of active connected recorder devices based on predetermined search criteria; and
a recorder communications module, responsive to the control module, configured to transmit the commands issued by said control module to the identified recorder device and receive the status updates from the connected recorder devices.

2. The apparatus of claim 1, further comprising:
a user database module configured to store user credentials and account information associated with the user;
an authentication module configured to authenticate the user by comparing the received user identification information with the user credentials; and
an encryption/decryption module configured to encrypt and decrypt communications to and from the user.

3. The apparatus of claim 1, wherein said control module commands the identified recorder device to record the selected multimedia content.

4. The apparatus of claim 3, wherein said priority logic module is configured to identify a further connected recorder device having an available tuner from the roster of active connected recorder devices, responsive to an interrupted recording of the selected multimedia content, and said control module is configured to command the further connected recorder device to continue recording an unrecorded portion of the multimedia content.

5. The apparatus of claim 4, wherein responsive to a completed recording of the interrupted multimedia content by the further connected recorder device, said control module tracks the transfer of the recorded multimedia content from the identified recorder device and the further network recorder device to a user-associated connected recorder device.

6. The apparatus of claim 3, wherein responsive to the recording of the selected multimedia content, said control module tracks the transfer of the recorded multimedia content from the identified recorder device to a user-associated connected recorder device.

7. The apparatus of claim 3, wherein responsive to the recorded multimedia content, said control module commands the identified recorder device to retain the recorded multimedia content until the recorded multimedia content is transferred.

8. The apparatus of claim 1, wherein the control module searches a user-associated connected recorder device for available tuner resources before looking to other connected recorder devices for an available tuner.

9. The apparatus of claim 8, wherein the control module is configured to search for available tuner resources by shortest geographic distance relative to the user's own connected recorder device.

10. The apparatus of claim 8, wherein the control module is configured to search for available tuner resources by fastest network connection relative to the user's own connected recorder device.

11. The apparatus of claim 3, wherein said control module is configured to command the identified recorder device to transfer the recorded multimedia content to one or more non-user-associated connected recorder devices.

12. The apparatus of claim 1, wherein said connected recorder devices are selected from the group consisting of digital video recorders (DVRs) and personal video recorders (PVRs).

13. A system for allocating tuner resources, comprising:
at least one server;
a plurality of recorder devices configured for connection to said at least one server, each recorder device having one or more tuners; and
a user interface to access said server and a user-associated recorder device,
wherein said server receives a multimedia broadcast record request from a user through said user interface, said server identifies a recorder device with an available tuner from among said plurality of recorder devices using predetermined search criteria, said server transmits a command to said identified recorder device to record the requested multimedia broadcast, and said identified recorder device automatically transfers the recorded multimedia broadcast to said user-associated recorder device.

14. The system of claim 13, wherein said server transmits a command over said network to said identified recorder device to transfer the recorded multimedia broadcast to one or more non-user-associated recorder devices.

15. The system of claim 13, wherein the server first searches said user-associated recorder device for available tuner resources.

16. The system of claim 15, wherein the server searches for available tuner resources by shortest geographic distance relative to said user-associated recorder device.

17. The system of claim 15, wherein the server searches for available tuner resources by fastest network connection relative to said user-associated recorder device.

18. The system of claim 13, wherein responsive to an interrupted recording of the requested multimedia broadcast, said server identifies a further recorder device having an available tuner from among said plurality of recorder devices using the predetermined search criteria and commands said further recorder device to continue recording a remaining portion of the requested multimedia broadcast.

19. The system of claim 18, wherein said identified recorder device transfers said interrupted multimedia broadcast portion to said user-associated recorder device and said further recorder device transfers said remaining multimedia broadcast portion to said user-associated recorder device, and wherein said user-associated recorder device joins said interrupted portion and said remaining portion to form a complete multimedia broadcast.

20. The system of claim 13, wherein said plurality of recorder devices are selected from the group consisting of digital video recorders (DVRs) and personal video recorders (PVRs).

21. A method of allocating tuner resources, comprising:
at a server connected to a plurality of recorder devices, accessing a schedule of multimedia broadcasts;
receiving a request to record a selected multimedia broadcast from the schedule of multimedia broadcasts;
searching the plurality of recorder devices for a recorder device with an available tuner using a predetermined search method;
responsive to a first command sent by the server, recording, at the recorder device with the available tuner, the selected multimedia broadcast; and
transmitting, from the recorder device with the available tuner, the recorded multimedia broadcast to a user-associated recorder device.

22. The method of claim 21, further comprising authenticating a user at the server to access the schedule of multimedia broadcasts.

23. The method of claim 21, further comprising, responsive to a second command sent by the server, retaining at the recorder device with the available tuner the recorded multimedia broadcast until said transmitting occurs.

24. The method of claim 21, wherein the predetermined search method first searches the user-associated recorder device for available tuner resources.

25. The method of claim 24, wherein if the user-associated recorder device has no available tuner resources, searching the connected recorder devices in order of shortest geographic distance relative to the user-associated recorder device.

26. The method of claim 24, wherein if the user-associated recorder device has no available tuner resources, searching the connected recorder devices in order of fastest network connection relative to the user-associated client device.

27. The method of claim 21, further comprising receiving status updates on said transmitting from the recorder device with the available tuner and the user-associated recorder device.

28. The method of claim 21, wherein if the recording of the multimedia broadcast is interrupted, searching for a further recorder device with an available tuner using the predetermined search method, and commanding the further recorder device to record a remaining portion of the multimedia broadcast.

29. The method of claim 28, further comprising transmitting, from the further recorder device, the remaining portion of the multimedia broadcast to the user-associated recorder device, and joining the interrupted multimedia broadcast portion and the remaining multimedia broadcast portion to form a complete multimedia broadcast.

30. A computer-readable medium encoded with a computer-executable program to perform a method comprising:
at a server connected to a plurality of recorder devices, accessing a schedule of multimedia broadcasts;
receiving a request to record a selected multimedia broadcast from the schedule of multimedia broadcasts;
searching within the plurality of recorder devices for a recorder device with an available tuner using a predetermined search method;
responsive to a first command sent by the server, recording, at the recorder device with the available tuner, the selected multimedia broadcast; and
transmitting, from the recorder device with the available tuner, the recorded multimedia broadcast to a user-associated recorder device.

31. The computer-readable medium of claim 30, further comprising authenticating a user at the server to access the schedule of multimedia broadcasts.

32. The computer-readable medium of claim 30, further comprising, responsive to a second command sent by the server, retaining at the recording device with the available tuner the recorded multimedia broadcast until said transmitting occurs.

33. The computer-readable medium of claim 30, wherein the predetermined search method first searches the user-associated recorder device for available tuner resources.

34. The computer-readable medium of claim 33, wherein if the user-associated recorder device has no available tuner resources, searching the connected recorder devices in order of shortest geographic distance relative to the user-associated recorder device.

35. The computer-readable medium of claim 33, wherein if the user-associated recorder device has no available tuner resources, searching the connected recorder devices in order of fastest network connection relative to the user-associated client device.

36. The computer-readable medium of claim 30, further comprising receiving status updates on said transmitting from the recorder device with the available tuner and the user-associated recorder device.

37. The computer-readable medium of claim 30, wherein if the recording of the multimedia broadcast is interrupted, searching for a second recorder device with an available tuner using the predetermined search method, and commanding the second recorder device to record a remaining portion of the multimedia broadcast.

38. The computer-readable medium of claim 37, further comprising transmitting, from the second recorder device, the remaining portion of the multimedia broadcast to the user-associated recorder device, and joining the interrupted multimedia broadcast portion and the remaining multimedia broadcast portion to form a complete multimedia broadcast.
